(19) United States
(12) Patent Application Publication
(10) Pub. No.: US 2025/0386219 A1
(43) Pub. Date: Dec. 18, 2025

(54) CELLULAR NETWORK REQUIREMENT TESTING

(71) Applicant: DISH Wireless L.L.C., Littleton, CO (US)

(72) Inventors: Ahmed Alkarboly, Denver, CO (US); Maria Manisha Miranda, Denver, CO (US); Anaghaa M. Londhe, Denver, CO (US); Media Shakiba Johnsen, Denver, CO (US); Jennings Orcutt, Denver, CO (US)

(21) Appl. No.: 18/741,033

(22) Filed: Jun. 12, 2024

(51) Int. Cl. H04W 24/08; G06V 30/246; H04W 84/02

(52) U.S. Cl. CPC H04W 24/08; G06V 30/246; H04W 84/02

(57) ABSTRACT

Arrangements detailed herein are directed to a requirement test system for a cellular network. Arrangements allow for technical requirements from digitized documents to be extracted. Each of the technical requirements are mapped in a technical requirement repository to at least one cellular network test to be performed on the cellular network. The execution of the cellular network test is performed to determine compliance with the technical requirements extracted from the digitized document.

### FIELD

The present invention generally relates to processing data, and more particularly, extracting from a digitized document and creating a centralized repository.

### BACKGROUND

Existing solutions for document and network management are manual, disaggregated and reactive. Currently, there is no end-to-end solution, which automatically extracts requirements from digitized documents, creates databases, and triggers automated testing of a network. In addition, finance and account related actions related to deliverables, quality of the network, and more are mainly executed manually.

There are no systems that track technical requirements; or in general, track technical requirements in a digitized document in an automated manner against a network and identify if those technical requirements are met or completed. Further, there are no cohesive processes that connect test cases against technical requirements of the network.

Thus, a technique to extract unstructured data from a digitized document, create a database with structured extracted data, run tests on a network while being connected and compared against the structured data in the database may be beneficial.

### SUMMARY

Various embodiments are described related to a cellular network test system. In some embodiments, a cellular network test system is described. The system may comprise a requirement test system, comprising one or more processors. The one or more processors may be configured to ingest a digitized document into an extraction platform. The one or more processors may be configured to extract a plurality of technical requirements from the digitized document. The one or more processors may be configured to map each of the one or more technical requirements in a technical requirement repository to at least one cellular network test to be performed on a cellular network. The one or more processors may be configured to cause the execution of the at least one cellular network test to determine compliance with the plurality of technical requirements extracted from the digitized document.

Embodiments of such a system may include one or more of the following features: the system may comprise a cellular network comprising a cellular network core. The requirement test system may be further configured to perform a standardization of unstructured data within the digitized document. The performing of the standardization may comprise cleaning of the unstructured data into a structured format to filter non-technical requirements from the digitized document. The performing of the standardization may comprise extracting the one or more technical requirements from the digitized document using a large language model (LLM). The requirement test system may be further configured to perform a similarity analysis on the plurality of technical requirements. The performing of the similarity analysis may comprise filtering at least one of the plurality of technical requirements determined to be similar to at least one of an existing technical requirement in the technical requirement repository. A Cosine algorithm, a Jaccard algorithm, or both, may be used to perform the similarity analysis of the plurality of technical requirements to filter the at least one of the one or more similar technical requirements. The requirement test system may be further configured to generate, using the Cosine algorithm, the Jaccard algorithm, or both, a ratio to identify a similarity between at least one of the plurality of technical requirements and at least one of the existing technical requirement in a technical data repository. The requirement test system may be further configured to store the plurality of technical requirements and the ratio associated with each of the plurality of technical requirements in the technical requirement repository.

In some embodiments, a method for tracking compliance for deliverables of a cellular network is described. The method may comprise ingesting, by a requirement test system, a digitized document into an extraction platform. The method may comprise extracting, by the requirement test system, a plurality of technical requirements from the digitized document. The method may comprise mapping, by the requirement test system, each of the one or more technical requirements in a technical requirement repository to at least one cellular network test to be performed on the cellular network. The method may comprise causing, by the requirement test system, the execution of the at least one cellular network test to determine compliance with the plurality of technical requirements extracted from the digitized document.

Embodiments of such a method may include one or more of the following features: the requirement test system may be part of the cellular network. The cellular network may comprise a cellular network core. The method may further comprise performing, by the requirement test system, a standardization of unstructured data within the digitized document. The performing of the standardization may comprise cleaning of the unstructured data into a structured format to filter non-technical requirements from the digitized document. Performing of the standardization may comprise extracting the one or more technical requirements from the digitized document using a large language model (LLM). The method may further comprise performing, by the requirement test system, a similarity analysis on the plurality of technical requirements. The performing of the similarity analysis may comprise filtering at least one of the plurality of technical requirements determined to be similar to at least one of an existing technical requirement in the technical requirement repository. A Cosine algorithm, a Jaccard algorithm, or both, may be used to perform the similarity analysis of the plurality of technical requirements to filter the at least one of the one or more similar technical requirements. The method may further comprise generating, using the Cosine algorithm, the Jaccard algorithm, or both, a ratio to identify a similarity between at least one of the plurality of technical requirements and at least one of the existing technical requirement in a technical data repository. The method may further comprise storing, by the requirement test system, the plurality of technical requirements and the ratio associated with each of the plurality of technical requirements in the technical requirement repository.

In some embodiments, a non-transitory processor-readable medium is described. The medium may comprise processor-readable instructions. The instructions may be configured to cause one or more processors to ingest a digitized document into an extraction platform. The instructions may be configured to cause one or more processors to extract a plurality of technical requirements from the digitized document. The instructions may be configured to cause one or more processors to map each of the one or more technical requirements in a technical requirement repository to at least one cellular network test to be performed on a cellular network. The instructions may be configured to cause one or more processors to cause the execution of the at least one cellular network test to determine compliance with the plurality of technical requirements extracted from the digitized document.

Embodiments of such a medium may include one or more of the following features: the processor-readable instructions may be further configured to cause the one or more processors to perform a standardization of unstructured data within the digitized document. The performing of the standardization may comprise cleaning of the unstructured data into a structured format to filter non-technical requirements from the digitized document. The performing of the standardization may comprise extracting the one or more technical requirements from the digitized document using a large language model (LLM). The processor-readable instructions may be further configured to cause the one or more processors to perform a similarity analysis on the plurality of technical requirements. The performing of the similarity analysis may comprise filtering at least one of the plurality of technical requirements determined to be similar to at least one of an existing technical requirement in the technical requirement repository. A Cosine algorithm, a Jaccard algorithm, or both, may be used to perform the similarity analysis of the plurality of technical requirements to filter the at least one of the one or more similar technical requirements.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings.

FIG. 1 illustrates a block diagram of an embodiment of a document management system that extracts and stores technical requirements embedded within digitized documents.

FIG. 2 illustrates an embodiment of a method for tracking compliance for deliverables of a cellular network.

FIG. 3 illustrates an embodiment of a compliance framework.

FIG. 4 illustrates an embodiment of a dashboard graphical user interface (GUI).

FIG. 5 illustrates an embodiment of a method for performing the automation of method 200.

FIG. 6 illustrates an embodiment of an architectural diagram illustrating a computing system configured to digitize a document and test telecommunication network performance based on the digitized document.

FIG. 7 illustrates an embodiment of a user interface used to validate authoritative mappings.

### DETAILED DESCRIPTION

Embodiments pertain to extracting requirements from a digitized document. The digitized document may be in portable document format (PDF), word format, Microsoft™ Excel™ format, or some other digital document format. A digitized document can include parameters for how a network, such as a cellular network, should be operating or how the network should be deployed. As an example, a client of a cellular network may draft a document defining particular key performance indicators (KPIs) which a cellular network slice that services devices of the client are required by a service level agreement (SLA) agreed to by the entity and the cellular network operator. In some embodiments, the digitized document can be the SLA itself. As another example, when a vendor's component is incorporated into an open radio access network (ORAN) cellular network or implemented on a public cloud computing platform, certain technical requirements need to be met by the system and other components that are communicating with the vendor's component in order for the vendor's component to function properly. These technical requirements can be explained in a document primarily intended to be read by a system architect or administrator. Further, the vendor's component can be required to meet certain performance metrics, which also need to be verified through testing to ensure they are realized when the component is incorporated into the cellular network.

The extracted technical requirements are stored digitally in a database or other form of data storage repository. The digitized document may be placed in an authoritative datastore. The term repository is used moving forward to refer to these possible storage arrangements.

Test cases are built or created based on the technical requirements that are now stored in the repository. The test cases can then be executed to test the network against the specific technical requirements written into the repository to determine if the desired performance metrics are met. This allows for a matrix of technical requirements for each digitized document (e.g., SLA) to be considered, and determine how the application or service is behaving on the network.

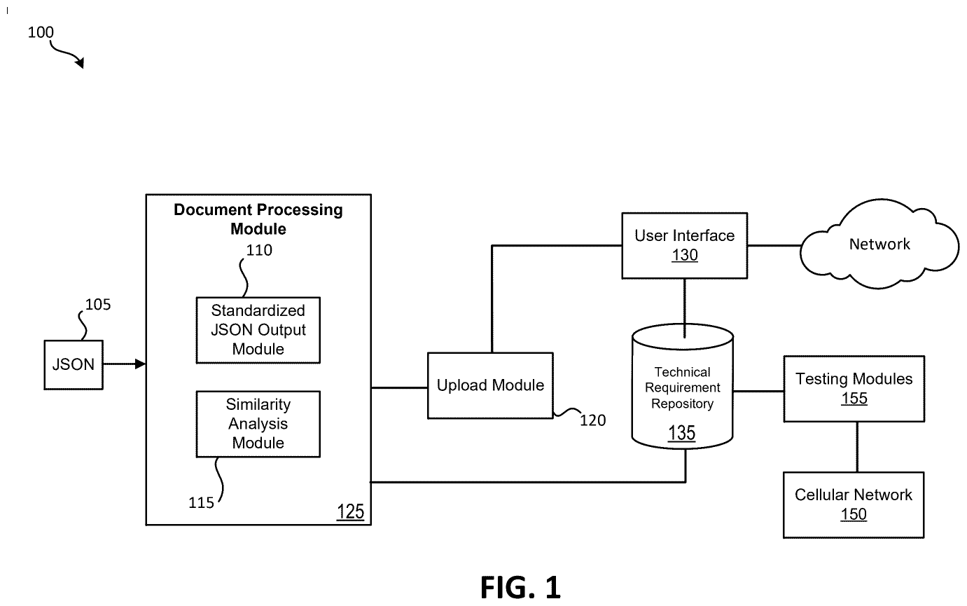

FIG. 1 is a block diagram illustrating a requirement test system 100 (“system 100”) that extracts and stores technical requirements embedded within a digitized document, according to an embodiment of the present invention. Specifically, system 100 can be configured to capture technical requirements from SLAs for which a slice of the cellular network is required to meet particular KPIs. In system 100, a digitized document 105, such as an SLA, is received. For example, the document can be in a standardized Java Script Object Notation (JSON) format. The digitized document may have been originally in the form of a PDF, .doc, .docx, .txt, or image file. Digitized document 105 contains a plurality of technical requirements, which are extracted by a document processing module 125 in conjunction with other modules. In some embodiments, system 100 includes three different/modules-standardized JSON output module 110, a similarity analysis module 115, and upload module 120.

Standardized JSON output module 110 is configured to standardize the data extracted from digitized document (e.g., JSON file) 105. The standardizing of the data includes converting the data into a table such as a data frame that organizes data into rows and columns. The data frame can be a two-dimensional (2D) array-like structure. In this embodiment, digitized document 105, which has different key value pairs, is parsed such that only certain columns and rows that have technical requirements are extracted. The technical requirements within digitized document 105, with certain columns and rows, are converted using an algorithm into the data frame. By converting the requirements into the data frame, duplicative data can be removed. In short, any data (e.g., key value pairs) that is not necessary is removed (e.g., the data file is cleaned up) while keeping only those key value pairs that are necessary. For example, data that is not associated with technical requirements is removed.

Next, similarity analysis module 115 compares the converted data with data previously stored in the repository. For example, two different technical requirements for the same component are compared using two different artificial intelligence (AI) algorithms. In this embodiment, in order to perform the similarity analysis, a Cosine algorithm and a Jaccard algorithm is executed to compare the data frame from the digitized document with the data frame already existing in the database. This comparison determines how similar the requirements are between two different vectors. In some embodiments, a similarity score is assigned to determine how similar the two vectors are. For example, if the comparison shows that the data frame includes technical requirements already stored in the repository, the technical requirements that is duplicative can removed.

In some embodiments, a machine learning algorithm is trained using data that has already been analyzed. The machine learning algorithm may use a training set that includes: 1) requirement documents; and 2) technical requirements that have been extracted from such documents and verified to be accurate (ground truth data). Once trained, the machine learning model, which may be in the form of a neural network, may be used to extract technical requirements from additional requirement documents.

System 100 can be designed to build a standardized repository to enable a simple testing module to have the ability to test requirements across multiple vendors and domains. For example, system 100 creates a pipeline that takes unstructured PDF data and transforms the unstructured PDF data into organized data tables. The data tables may include a technical requirements identifier (ID), the technical requirements, and vendor name. In short, system 100 is configured to generate unique identifiers and data based on a PDF or other document format, allowing automated testing systems to track requirements in a document in an automated manner against a network and identify if those requirements are met.

Upload module 120 can obtain requirements extracted by document processing module 125 and provide to a user for viewing and editing in user interface 130.

After being processed using document processing module 125, technical requirements captured from a document can be presented via user interface 130. User interface 130 can be used by a user to compare to an original document (e.g., PDF) and validate data prior to uploading of the data to technical requirement repository 135. For example, a user can remap requirements to a correct cellular network component or adjust requirements that were captured inaccurately. Redundant requirements can be screened out by the user. Upon validating and cleaning of the validated data, the validated requirement data is uploaded to technical requirement repository 135.

Testing modules 155 can conduct tests on cellular network 150. Once various tests have been performed, the results can be mapped to and compared with specific technical requirements present in technical requirement repository 135. Therefore, by performing one or more particular tests, compliance of one or more cellular network functions, components, or a cellular network slice with one or more technical requirements that have been stored in requirement repository 135 can be determined. Tests conducted using testing modules 155 can be conducted on an active cellular network (e.g., cellular network 150) or can be conducted on an instantiation of some or all cellular network components.

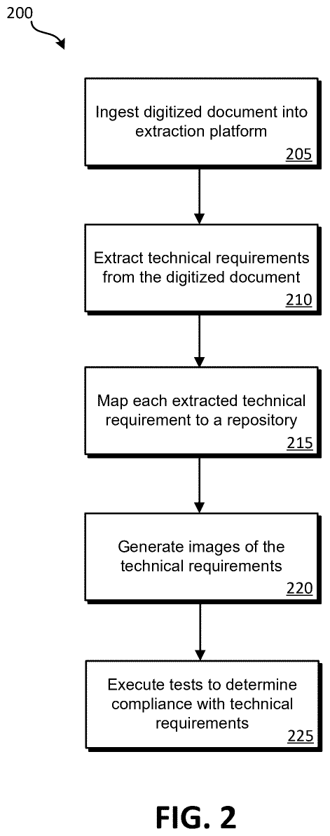

FIG. 2 is a flow diagram illustrating an embodiment of a method 200 for tracking compliance for deliverables. As an example, a contractual agreement can exist with a cellular network vendor. In this example, there may be a technical requirements page in the form of an Microsoft™ Excel™ spreadsheet. In the spreadsheet, the following fields may be included: requirement identifier, requirement descriptor, vendor response. Once the technical requirements are finalized between the customer (e.g., cellular network operator) and the vendor, the technical requirements are ready to be placed inside of a contract (e.g., a digital document). Once the contract is signed by both parties, a project manager is assigned to the contract to ensure that the technical requirements are delivered by the vendor.

In contrast, method 200 allows for the standardization of a central repository of technical requirements. The central repository organizes the information (e.g., technical requirements) from various contracts and SLAs. In one embodiment, the technical requirements may be stored in PDF format or Excel format. Method 200 uses multiple extraction techniques to extract the technical requirements from the contracts and uses multiple similarity analysis techniques to determine if the extracted technical requirements are duplicate. As an example, if two contracts require that a particular cellular network component meet a same performance metric, the requirement of meeting the performance metric may only need to be stored once. A value, “requirement ID,” can be stored that serves as a unique identifier for a particular requirement. As such, every requirement stored to technical requirement repository 135 is mapped to a unique requirement ID.

If multiple components require a same requirement, each of the components can be mapped to the same requirement ID. If multiple components require different values for a same requirement, the requirement ID can be mapped to multiple requirement values. As an example of this, Vendor A might specify a latency of 10 ms, while Vendor B specifies 5 ms for the same component, such as due to contract start date variations. By mapping to the same requirement ID, it can be determined if the requirement is met for none, one, or both vendors. This allows for informed decisions and the ability to request improvements from vendors based on current standards.

A similarity analysis can obtain a technical requirement from a digitized document and maps it to a technical requirement that already exists within technical requirement repository 135. For example, three vendors may sell a component that functions in a cellular network core and those three vendors agree to the same technical requirements. Each of the three vendor's components can then be evaluated against the same technical requirement, which is mapped to the same requirement ID.

With method 200, a digitized document (e.g., a PDF document) is ingested into an extraction platform at block 205. At block 210, the extraction platform extracts (or parses out) technical requirements from the digitized document into a standardized format that is usable across one or more platforms. In some embodiments, the expected output is a standardized JSON template. Rather than looking for keywords and text matches, a large language module (LLM) is leveraged to extract tabularized data relevant to the contract. The LLM is more dynamic, i.e., the LLM is contract agnostic in so far that different technical requirements are extracted from any contract regardless of format.

At block 215, each extracted technical requirement is mapped and stored to a repository of requirements. A user interface can be used by a user to modify the mapping of requirements in the repository. In continuing with the example of there being three core vendors, since the vendors are performing the same tasks, in order to consolidate compliance, all contracts are viewed and all technical requirements in the contracts are mapped to the repository (e.g., SQL database or a serverless database). This is achieved through the use of several similarity modules.

Once the data is stored in the repository, at block 220, additional automations are performed to generate an image of the technical requirements. For example, once the requirements are categorized and are in the right format, automation (e.g., via Jira) may be performed to register the technical requirements in a hierarchy. This enables interfacing with automated testing modules. These testing modules automate testing requirements of the technical requirements for all vendors, since all vendors are now on the same compliance framework. Because the technical requirements are registered from the repository in a management software (e.g., Jira) in a standardized way, compliance may now be judged.

At block 225, one or more tests are caused to be executed that determine compliance with the technical requirements extracted from the digitized document. After completion of a test, results from the test can be compared with corresponding requirements in technical requirement repository 135. These tests may be preexisting tests that cause various testing modules to execute tests (e.g., load tests, latency) one specific components of a cellular network (e.g., components within the core). For example, for a technical requirement that requires that a particular cellular network core component have a response latency of less than a predefined value when operating under full load, a test that causes the particular cellular network core to operate under full load may be executed. The latency of the particular cellular network core can then be measured to determine if the measured latency meets the requirement.

Following block 225, results can be provided for review by a user that indicate which technical requirements from technical requirement repository 135 were met and which were not met.

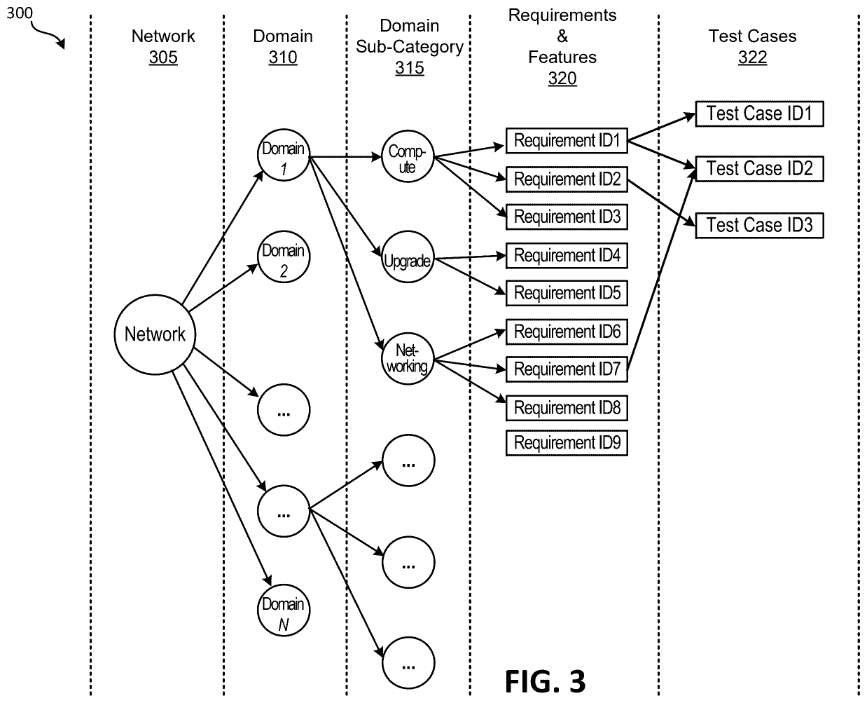

FIG. 3 is a diagram illustrating a compliance framework 300, according to an embodiment of the present invention. In FIG. 3, a network 305 may have several domains (e.g., domain 1, domain 2, . . . domain N) 310. In one example, within domain 1, there may be domain sub-categories (e.g., compute, upgrade, networking, etc.) 315. Those domain sub-categories 315 are extracted from an appendix of a master software agreement, SLA, or vendor contract. Within each domain sub-category 315, there are different requirements and features 320. The gap that FIG. 3 shows and method 200 of FIG. 2 resolves is associating or cataloging in a useful way the relationship between technical requirements 320 and test cases 322. This is critical for moving to an automated testing environment instead of manually performing a one-time validation test.

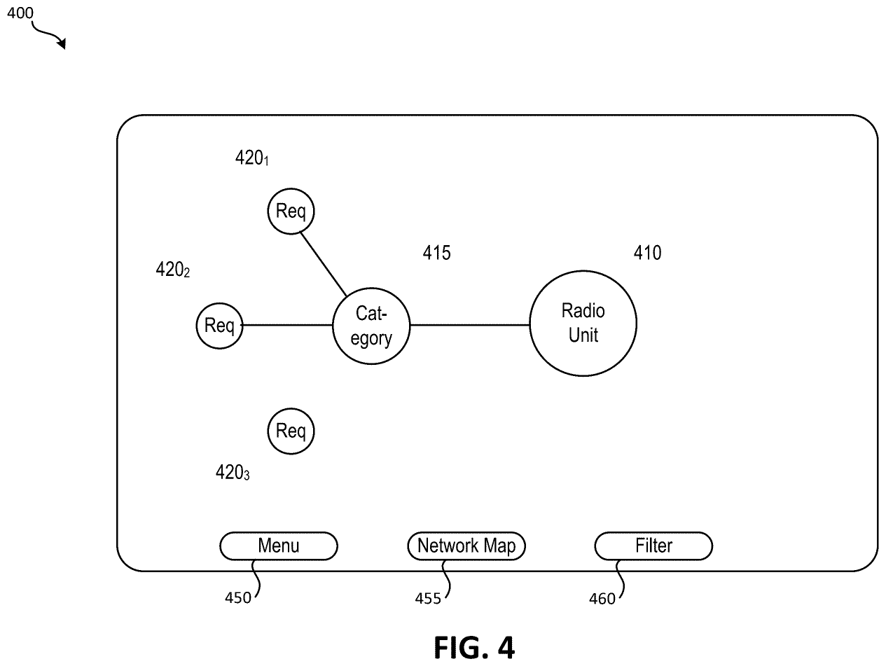

FIG. 4 is a GUI 400 illustrating a dashboard 405, according to an embodiment of the present invention. Dashboard 405 may have a plurality of buttons such as menu option 450, network map 455, and filter 460. It should be appreciated that there may be any number of buttons allowing the user to select from, and allowing for additional functionalities to be performed. In some embodiments, because management of technical requirements are performed inside of dashboard 405, when a user selects on network map 455 button, dashboard 405 produces network maps to show compliance and connections between technical requirements and vendors. For example, in GUI 400, dashboard 405 shows a connection between master node (radio unit) 410, node (category) 415, and child nodes (technical requirements) 4201, 4202. Dashboard 405 also shows a break or non-compliance between node 415 and one of child nodes (technical requirements) 4203. In some embodiments, the dashboard may show the compliance per category. Further, the dashboard allows the user using filter 460 button to filter by vendor and/or domain (e.g., system architecture, automation, centralized management, compute, multi-cloud computing, etc.). The dashboard may also give visibility on orphan test cases, domain, domain sub-category, vendor issues, test case key, test case status, vendor contracts, etc.

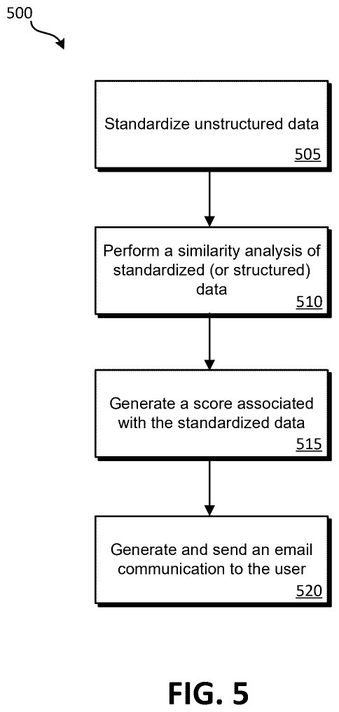

FIG. 5 is a flow diagram illustrating method 500 for performing the automation of method 200 shown in FIG. 2 without any human intervention, according to an embodiment of the present invention. In this embodiment, digitized documents (e.g., contracts, SLAs) are uploaded in a data storage arrangement or database. These digitized documents are unstructured with irrelevant information and include fields under different labels. This makes it difficult to determine what information is necessary in the digitized document.

To overcome this issue, method 500 begin at block 505 with performing standardization of unstructured data. For example, once the digitized document is uploaded to a bucket, an event is initiated to trigger a λ function. The λ function standardizes and cleans the unstructured data into a structured format that can be further consumed. For example, A function uses a LLM to filters irrelevant information (i.e., non-technical requirements) from standardized document. Additionally, the λ function extracts technical requirements, and in some embodiments, assigns an identifier (i.e., an ID) to each extracted technical requirement. This way, the technical requirement, along with its corresponding ID, is now in a structured format.

At block 510, method 500 includes performing similarity analysis on the structured data. For example, once the λ function from step 505 standardizes and cleans the unstructured data, the structured data is now saved in the repository. At block 510, a second A function performs a similarity analysis on the structured data, comparing existing and new requirements, thereby providing a similarity score for each new requirement against each existing requirement. For example, when uploading the technical requirements from the digitized document (originally in unstructured data format), there is a possibility that the requirements already exist in the repository. In this example, there are two types of data—(1) data (existing technical requirements) already existing in the database and (2) new data (new stored technical requirements) that is standardized/waiting for processing. The comparison is performed between both the existing technical requirements and the new stored technical requirements.

As briefly mentioned above, there are at least two types of similarity analysis—a Cosine algorithm and a Jaccard algorithm. In one embodiment, a Jaccard algorithm is used to compare the common tokens (or words) in both of the technical requirements' descriptions. From there, a ratio for a particular value against the entire words in the technical requirements' descriptions is evaluated, and a similarity score is returned. For Cosine similarity, there is a focus on how similar each word in a technical requirement is against another word in another technical requirement, to determine if there is redundancy.

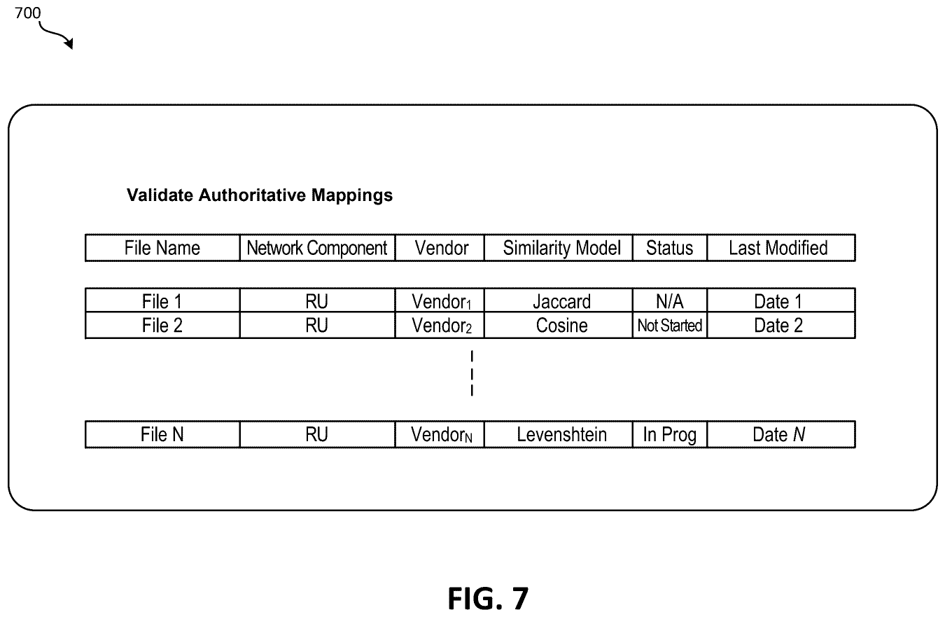

The similarity analysis may return a score for the technical requirement in the structured data. This score is also saved in the repository and is associated with the corresponding technical requirements at block 515. In some embodiments, UI module interfaces with a pipeline, and is a tool assisted method for data processing. Once the user is prompted via email after the similarity analysis is performed the user validates the data and the data is uploaded to the central repository. See, for example, FIG. 7, which is a GUI 700 illustrating a “validate authoritative mappings” UI, according to an embodiment of the present invention. In some embodiments, the validate authoritative mappings UI allows a user to select a file to validate the authoritative mappings, which have not been processed.

Returning to FIG. 5, at block 520, an email is automatically generated and sent to the user notifying the user that the technical requirements and the corresponding similarity score is saved in the database for further processing and review. This allows the user to view the similarity score and the technical requirements in the dashboard and determine if he or she would like to remove the redundant technical requirements from the repository.

In another embodiment, based on the similarity score, the technical requirements are stored in the repository. For example, if two different requirements from two different digitized documents are similar, the score, which is populated by the similarity analysis, is or near 1. If there are two different requirements from two different digitized documents that are not similar, the score is at or near 0. In short, every new technical requirement is compared against every existing technical requirement. This way, the user or the computing system may determine if the technical requirement should be saved in the repository or discarded.

Returning to the example of the three core vendors, a technical requirement in vendor A's digitized document may have an ID number 7 assigned, a same technical requirement in vendor B's digitized document may have an ID number 79 assigned, and the same technical requirement in vendor C's digitized document may have an ID number 759 assigned. In this case, the technical requirements are the same, and there would be not need to store the same technical requirements in the repository twice or more. Instead, method 500 generates a single requirement ID, which is tracked centrally for the technical requirements of all vendors. This way, the same test case can be applied to all three vendors.

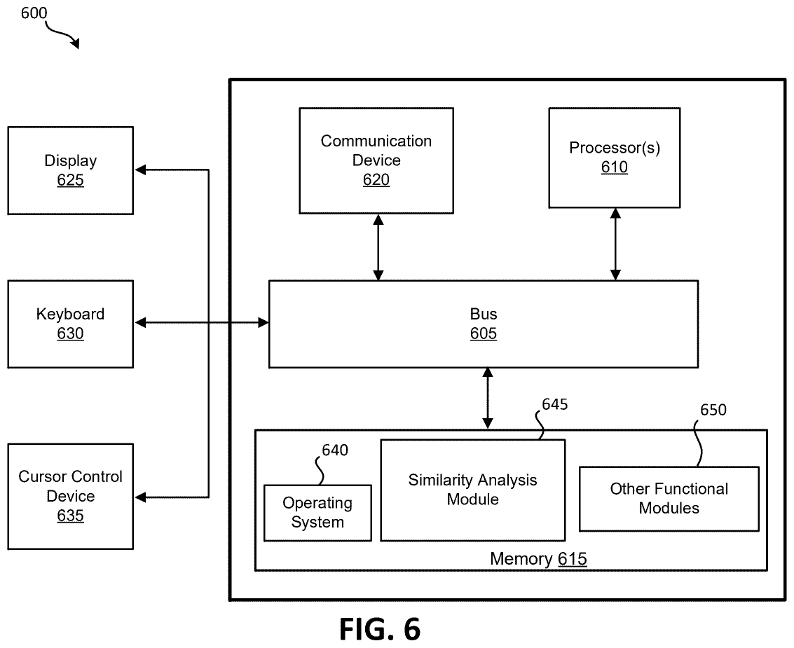

FIG. 6 is an architectural diagram illustrating a computing system 600 configured to digitize a document and test telecom network performance based on the digitized document, according to an embodiment of the present invention. In some embodiments, computing system 600 may be one or more of the computing systems depicted and/or described herein. Computing system 600 includes a bus 605 or other communication mechanism for communicating information, and processor(s) 610 coupled to bus 605 for processing information. Processor(s) 610 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 610 may also have multiple processing cores, and at least some of the cores may be configured to perform specific functions. Multi-parallel processing may be used in some embodiments. In certain embodiments, at least one of processor(s) 610 may be a neuromorphic circuit that includes processing elements that mimic biological neurons. In some embodiments, neuromorphic circuits may not require the typical components of a Von Neumann computing architecture.

Computing system 600 further includes a memory 615 for storing information and instructions to be executed by processor(s) 610. Memory 615 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 610 and may include volatile media, non-volatile media, or both. The media may also be removable, non-removable, or both.

Additionally, computing system 600 includes a communication device 620, such as a transceiver, to provide access to a communications network via a wireless and/or wired connection. In some embodiments, communication device 620 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the invention. In some embodiments, communication device 520 may include one or more antennas that are singular, arrayed, phased, switched, beamforming, beamsteering, a combination thereof, and or any other antenna configuration without deviating from the scope of the invention.

Processor(s) 610 are further coupled via bus 605 to a display 625, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. Display 625 may be configured as a touch (haptic) display, a three-dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 630 and a cursor control device 635, such as a computer mouse, a touchpad, etc., are further coupled to bus 605 to enable a user to interface with computing system 600. However, in certain embodiments, a physical keyboard and mouse may not be present, and the user may interact with the device solely through display 625 and/or a touchpad (not shown). Any type and combination of input devices may be used as a matter of design choice. In certain embodiments, no physical input device and/or display is present. For instance, the user may interact with computing system 600 remotely via another computing system in communication therewith, or computing system 600 may operate autonomously.

Memory 615 stores software modules that provide functionality when executed by processor(s) 610. The modules include an operating system 640 for computing system 600. The modules further include a similarity analysis module 645 that is configured to perform all or part of the processes described herein or derivatives thereof. Computing system 600 may include one or more additional functional modules 650 that include additional functionality.

One skilled in the art will appreciate that a “computing system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public cloud computing system (e.g, Amazon™ AWS) or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process steps performed in FIGS. 2 and 5 may be performed by computer program(s), encoding instructions for the processor(s) to perform at least part of the process(es) described in FIGS. 2 and 5, in accordance with embodiments of the present invention. The computer program(s) may be embodied on non-transitory computer-readable media. The computer-readable media may be, but are not limited to, a hard disk drive, a flash device, RAM, a tape, and/or any other such medium or combination of media used to store data. The computer program(s) may include encoded instructions for controlling processor(s) of computing system(s) (e.g., processor(s) 610 of computing system 600 of FIGS. 2 and 5) to implement all or part of the process steps described in FIGS. 2 and 5, which may also be stored on the computer-readable medium.

The computer program(s) can be implemented in hardware, software, or a hybrid implementation. The computer program(s) can be composed of modules that are in operative communication with one another, and which are designed to pass information or instructions to display. The computer program(s) can be configured to operate on a computing system, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

What is claimed is:

1. A cellular network test system, comprising:
a requirement test system, comprising one or more processors, configured to:
ingest a digitized document into an extraction platform;
extract a plurality of technical requirements from the digitized document;
map each of the one or more technical requirements in a technical requirement repository to at least one cellular network test to be performed on a cellular network; and
cause the execution of the at least one cellular network test to determine compliance with the plurality of technical requirements extracted from the digitized document.

2. The cellular network test system of claim 1, further comprising a cellular network comprising a cellular network core.

3. The cellular network test system of claim 1, wherein the requirement test system is further configured to:
perform a standardization of unstructured data within the digitized document, wherein the performing of the standardization comprises cleaning of the unstructured data into a structured format to filter non-technical requirements from the digitized document.

4. The cellular network test system of claim 3, wherein the performing of the standardization comprises extracting the one or more technical requirements from the digitized document using a large language model (LLM).

5. The cellular network test system of claim 1, wherein the requirement test system is further configured to:
perform a similarity analysis on the plurality of technical requirements, wherein the performing of the similarity analysis comprises filtering at least one of the plurality of technical requirements determined to be similar to at least one of an existing technical requirement in the technical requirement repository.

6. The cellular network test system of claim 5, wherein a Cosine algorithm, a Jaccard algorithm, or both, are used to perform the similarity analysis of the plurality of technical requirements to filter the at least one of the one or more similar technical requirements.

7. The cellular network test system of claim 6, wherein the requirement test system is further configured to:
generate, using the Cosine algorithm, the Jaccard algorithm, or both, a ratio to identify a similarity between at least one of the plurality of technical requirements and at least one of the existing technical requirement in a technical data repository.

8. The cellular network test system of claim 7, wherein the requirement test system is further configured to:
store the plurality of technical requirements and the ratio associated with each of the plurality of technical requirements in the technical requirement repository.

9. A method for tracking compliance for deliverables of a cellular network, comprising:
ingesting, by a requirement test system, a digitized document into an extraction platform;
extracting, by the requirement test system, a plurality of technical requirements from the digitized document;
mapping, by the requirement test system, each of the one or more technical requirements in a technical requirement repository to at least one cellular network test to be performed on the cellular network; and
causing, by the requirement test system, the execution of the at least one cellular network test to determine compliance with the plurality of technical requirements extracted from the digitized document.

10. The method for tracking compliance for deliverables of the cellular network of claim 9, wherein the requirement test system is part of the cellular network, the cellular network comprising a cellular network core.

11. The method for tracking compliance for deliverables of the cellular network of claim 9, further comprising:
performing, by the requirement test system, a standardization of unstructured data within the digitized document, wherein the performing of the standardization comprises cleaning of the unstructured data into a structured format to filter non-technical requirements from the digitized document.

12. The method for tracking compliance for deliverables of the cellular network of claim 11, wherein performing of the standardization comprises extracting the one or more technical requirements from the digitized document using a large language model (LLM).

13. The method for tracking compliance for deliverables of the cellular network of claim 9, further comprising:
performing, by the requirement test system, a similarity analysis on the plurality of technical requirements, wherein the performing of the similarity analysis comprises filtering at least one of the plurality of technical requirements determined to be similar to at least one of an existing technical requirement in the technical requirement repository.

14. The method for tracking compliance for deliverables of the cellular network of claim 13, wherein a Cosine algorithm, a Jaccard algorithm, or both, are used to perform the similarity analysis of the plurality of technical requirements to filter the at least one of the one or more similar technical requirements.

15. The method for tracking compliance for deliverables of the cellular network of claim 14, further comprising:
generating, using the Cosine algorithm, the Jaccard algorithm, or both, a ratio to identify a similarity between at least one of the plurality of technical requirements and at least one of the existing technical requirement in a technical data repository.

16. The method for tracking compliance for deliverables of the cellular network of claim 15, further comprising:
storing, by the requirement test system, the plurality of technical requirements and the ratio associated with each of the plurality of technical requirements in the technical requirement repository.

17. A non-transitory processor-readable medium comprising processor-readable instructions configured to cause one or more processors to:
ingest a digitized document into an extraction platform;
extract a plurality of technical requirements from the digitized document;
map each of the one or more technical requirements in a technical requirement repository to at least one cellular network test to be performed on a cellular network; and
cause the execution of the at least one cellular network test to determine compliance with the plurality of technical requirements extracted from the digitized document.

18. The non-transitory processor-readable medium of claim 17, wherein the processor-readable instructions are further configured to cause the one or more processors to:
perform a standardization of unstructured data within the digitized document, wherein:
the performing of the standardization comprises cleaning of the unstructured data into a structured format to filter non-technical requirements from the digitized document; and
the performing of the standardization comprises extracting the one or more technical requirements from the digitized document using a large language model (LLM).

19. The non-transitory processor-readable medium of claim 17, wherein the processor-readable instructions are further configured to cause the one or more processors to:
perform a similarity analysis on the plurality of technical requirements, wherein the performing of the similarity analysis comprises filtering at least one of the plurality of technical requirements determined to be similar to at least one of an existing technical requirement in the technical requirement repository.

20. The non-transitory processor-readable medium of claim 19, wherein a Cosine algorithm, a Jaccard algorithm, or both, are used to perform the similarity analysis of the plurality of technical requirements to filter the at least one of the one or more similar technical requirements.
